(19) United States
(12) Patent Application Publication
(10) Pub. No.: US 2025/0217668 A1
(43) Pub. Date: Jul. 3, 2025

(54) SAVING QUBITS BY OPTIMIZING ONE-HOT ENCODING GRANULARITY, RANGE, AND POINT DISTRIBUTION

(71) Applicant: Dell Products L.P., Round Rock, TX (US)

(72) Inventors: Diego Vrague Noble, Pelotas (BR); Miguel Paredes Quiñones, Campinas (BR); Ítalo Gomes Santana, Rio de Janeiro (BR)

(21) Appl. No.: 18/401,021

(22) Filed: Dec. 29, 2023

(51) Int. Cl. G06N 5/022

(52) U.S. Cl. CPC G06N 5/022

(57) ABSTRACT

A machine learning model is trained, using historical data, to generate distributions for integer variables of a problem. When a new problem or problem instance is presented, the model is used to predict a distribution for each of the integer variables. A range is determined from each of the distributions. One-hot encoded binary variables are generated from the ranges. This reduces the number of qubits needed to one-hot encode the problem instance.

### FIELD OF THE INVENTION

Embodiments of the present invention generally relate to quantum computing systems and quantum computing related operations. More particularly, at least some embodiments of the invention relate to systems, hardware, software, computer-readable media, and methods for encoding problems including quadratic binary unconstrained optimization (QUBO) models.

### BACKGROUND

A combinatorial problem often involves a scenario where there is a desire to identify a good or suitable solution from among a very large number of possible solutions. The traveling salesman problem is an example of a combinatorial optimization problem. Quantum computing systems, such as quantum annealers, are often used to identify a suitable solution to a combinatorial problem.

The combinatorial problem (or other type) may be represented in a format such as quadratic unconstrained binary optimization (QUBO) model. In one example, a QUBO is a single multivariable quadratic polynomial whose solution is obtained by minimizing an energy function in a quantum annealer.

When preparing to solve a problem in a quantum annealer, the problem may need to be transformed into the QUBO form. Transforming the problem may include converting integer variables or other kinds of variables to binary form. This may be achieved, for example, by performing log encoding or one-hot encoding.

Encoding optimization problems using this type of encodings has several disadvantages. One-hot encoding, for example, may consume a considerable number of qubits, one for each binary variable created by the encoding process. This may cause relatively small-scale problems to require qubits that are proportional to any integer value in their formulations. This problem may be made worse when matching the Hamiltonian to a quantum computing system with a non-fully connected topology.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1 discloses aspects of generating a representation of a QUBO that includes binary variables;

FIG. 2 discloses aspects of an orchestration engine configured to identify ranges of integer variables for performing one-hot encoding operations;

FIG. 3 discloses aspects of a method for encoding integer variables;

FIG. 4 illustrates aspects of point distributions based on predictions of a machine learning model; and

FIG. 5 discloses aspects of a computing device, system, or entity.

### DETAILED DESCRIPTION OF SOME EXAMPLE EMBODIMENTS

Embodiments of the present invention generally relate to quantum computing systems and related operations. More particularly, at least some embodiments of the invention relate to systems, hardware, software, computer-readable media, and methods for encoding problems into a format or model such as a quadratic unconstrained binary optimization (QUBO) model, which is an example of a quadratic binary model (QBM). QBMs are a general class of problems used by quantum annealers to sample solutions for a given problem.

Embodiments of the invention are discussed in the context of QUBO models, but are not limited thereto. Embodiments of the invention may be applied to other models including Ising models. Embodiments of the invention are further discussed in the context of quantum annealers including physical and simulated quantum annealers. Simulated quantum annealers are executed in classical computing systems that include processors, memory, and other hardware.

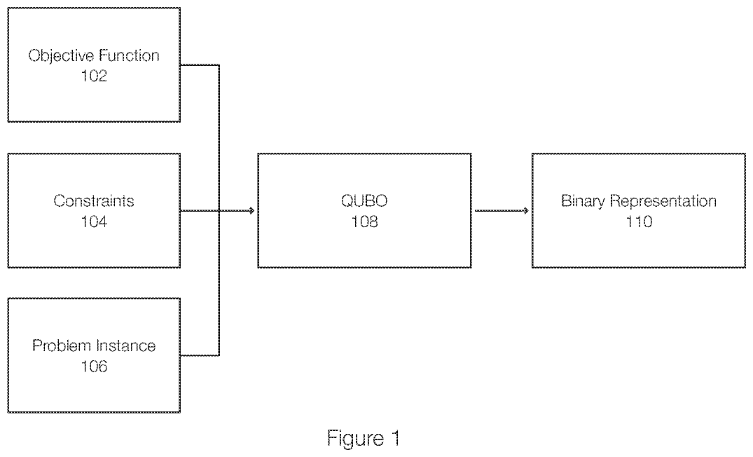

FIG. 1 discloses aspects of a QUBO. FIG. 1 illustrates an example where an objective function 102, constraints 104, and a problem instance 106 are transformed into a QUBO 108. The objective function 102 is often used to represent how a particular combination of variables satisfies or solves a problem such as a combinatorial problem. The objective function 102 mathematically expresses a problem using binary values xᵢ. For example, an objective function may be represented as:

$$Q ( x ) = {\sum }_{i = 1}^{N} {q}_{i} {x}_{i} + {\sum }_{j = i + 1}^{N} {q}_{ij} {x}_{i} {x}_{j} .$$

As illustrated, the objective function 102 may include a linear term and a quadratic term. When solving a QUBO, the goal is to identify the variable assignments that minimize the objective function 106. A QUBO may have a large number of variables and the process of determining or identifying a solution may attempt to select a best known or optimal solution from all of the possible combinations.

Although a QUBO may be unconstrained, the constraints 104 are often introduced. The constraints 104 may ensure that some unfeasible solutions are avoided. For example, the constraints 104 may be configured to penalize solutions that violate the constraints. The problem instance 106 may be a specific representation of a general problem definition in one example. The problem instance 106, for example, may include the parameters and constraints of a specific occurrence of the objective function 102.

Thus, in one example, the objective function 102, the constraints 104, and the problem instance 106 are transformed into the QUBO 108. The QUBO 108 may have a binary representation 110. The binary representation includes the binary variables.

For example, one-hot encoding may be used to encode integer variables as binary variables. In one example, an integer variable is one-hot encoded by adding a binary variable for each integer in the integer variable. More specifically, the integer variable v may be restricted to an interval as [vᵢ, v_{f}] such that vᵢ, v_{f} ∈ [symbol] , vᵢ<v_{f}. The integer variable v may be one-hot encoded to |v_{f}-vᵢ| binary variables represented by {xᵢ, xᵢ₊₁, . . . , x_{f}}. Thus, each integer within [vᵢ, v_{f}] may be represented as a binary variable:

$$v = {\sum }_{k = i}^{f} k \cdot {x}_{k} ; v ∈ [ {v}_{i} , {v}_{f} ] .$$

The selection of these binary variables may be reinforced by an auxiliary constraint of Σₖ₌ᵢ^{f}xₖ=1. As previously stated, this encoding scheme may consume a considerable number of qubits, one for each binary variable created for each of the problem's integer variables.

Embodiments of the invention relate to mitigating the overprovisioning of qubits associated with one-hot encoding schemes. Embodiments of the invention are configured to change the granularity of one-hot encoding schemes to save qubits (reduce the required number of qubits). Although the number of qubits is reduced in embodiments of the invention, precision may be increased in QUBO parts where one-hot encoding requires fine granularity using the saved qubits. Embodiments of the invention may also detect a best range and point distribution for the integers being one-hot encoded.

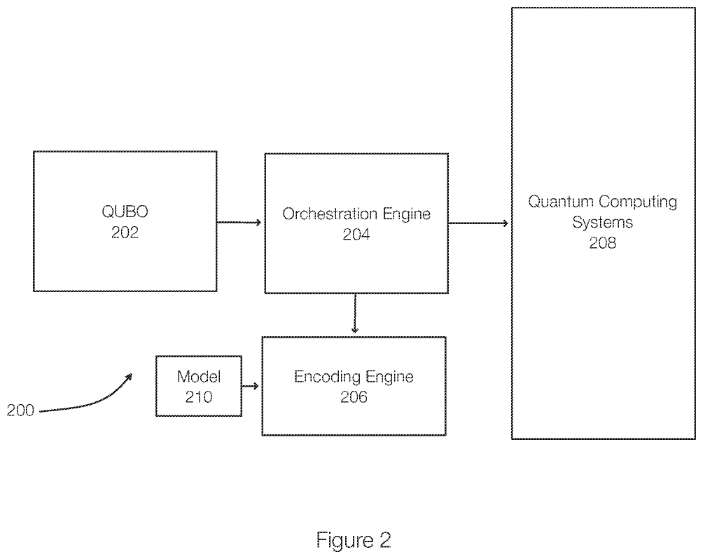

FIG. 2 discloses aspects of an orchestration system configured to orchestrate the execution of quantum jobs. FIG. 2 illustrates an orchestration system that includes an orchestration engine 204. The orchestration engine 204 may be a cloud-based service that includes servers or other computing devices with processors, memory, and networking hardware.

In one example, the orchestration engine 204 receives a QUBO 202 from a client. The orchestration engine 204 more generally receives a quantum job and may perform some processing to generate the QUBO 202. The orchestration engine 204 may perform various operations or tasks related to the execution of the QUBO 202. Example operations may include converting the QUBO 202 into a graph, performing minor graph embedding, mapping the QUBO to the qubits of a quantum computing system, which may be selected from quantum computing systems 208 available to the orchestration engine 204, or the like. The quantum computing systems 208 may include quantum computing systems, quantum annealers, both real and simulated. The orchestration engine 204 may submit the QUBO 202 to a selected quantum computing system and return results or a solution to the client.

As illustrated in FIG. 2, the orchestration system 200 (or the orchestration engine 204) may include or have access to an encoding engine 206. The encoding engine 206 is configured to perform various types of encoding including log encoding, unary encoding, one-hot encoding, or the like.

In one example, a machine learning model 210 is trained to generate distributions of integer variables for the QUBO 202. The distributions are used to generate ranges of the integer variables and the encoding engine 206 may perform one-hot encoding using the ranges of the integer variables rather than the full integer variables. For example, an integer variable may be represented as [0,100]. The model 210 may generate or predict a distribution and a range of [40,60] may be identified from the predicted distribution. The encoding engine 206 may then perform one-hot encoding using the range [40,60] of the integer variable. This reduces the number of qubits required for the problem or QUBO 202.

More specifically, the historical data may include information identifying which of the binary variables were activated in the QUBO solutions. Because each of the binary variables was an encoding of a corresponding integer in an integer variable, the machine learning model can use this information to learn which of the integers in an integer variable are most likely to be activated. Thus, the model may generate a distribution reflecting the probability of an integer being activated. This distribution can be used to generate a range (or subset of integers) whose interval is smaller than the interval of the original integer variable.

Embodiments of the invention relate to a focused one-hot encoding. A focused one-hot encoding may improve (e.g., by reducing the number of required qubits) the encoding operation using a machine learning model trained on historical data of solved problems in the context of quantum annealing. The model 210 is configured to generate or predict a distribution of integer variables associated with the QUBO such that smaller ranges can be identified and encoded.

More specifically, a particular problem or QUBO may include an integer variable delimited by [vᵢ, v_{f}]. A one-hot encoding of this integer variable would generate a binary variable for each integer in [vᵢ, v_{f}]. Thus, if vᵢ=0 and v_{f}=100, then a one-hot encoding of this integer variable would require 101 binary variables. The distribution predicted by the model 210 allows a smaller range [v_{i′}, v_{f′}] to be encoded, which uses fewer qubits.

When variations of a problem or similar problems are executed multiple times in a quantum annealer, multiple solutions may be generated. The execution of this problem or of similar problems multiple times generates data that can be used to train a model to predict a distribution of an integer variable.

For a new problem (or a new problem instance), the trained model may generate or predict a distribution for each of the problem's integer variables. The distribution of each integer variable may be associated with a mean and a standard deviation. In one example, a subset or range of the original interval [vᵢ, v_{f}] may be identified using the predicted distribution. This allows a specific integer values within [vᵢ, v_{f}] to be one-hot encoded. In one example, the range may include all integers that fall within three standard deviations. Using the example of vᵢ=0 and v_{f}=100, the distribution may indicate that the most likely range is 30-50. This requires 21 binary variables rather than 101 binary variables. Thus, the qubits required for this problem are reduced and the solution quality has a low likelihood of being affected significantly. In one example, due to the number of qubits that are being saved, the range can be extended if desired (e.g., 20-60).

The range, however, may not be consecutive and may depend on the distribution or other information known or not known. For example, a range including all odd integers of the original interval may be determined.

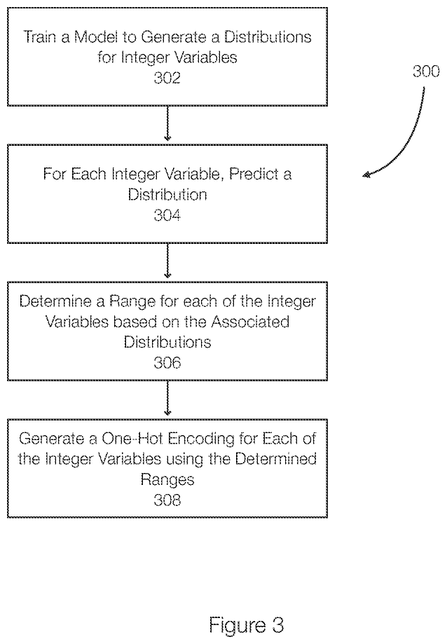

FIG. 3 discloses aspects of improving or optimizing encoding granularity, range, and/or distribution. More specifically, an integer variable v associated with a QUBO may defined by the interval [vᵢ, v_{f}]. Using historical data to train a machine learning model, embodiments of the invention may train the model to identify the most likely or probable values to be activated within the interval [vᵢ, v_{f}]. This allows some of the integers in the integer variable to, in effect, be omitted from the encoding operation. This reduces the encoding requirements of the QUBO.

In one example, a combinatorial problem P is amenable to be solved using a quantum annealer. A historical database D with previous QUBOs from the problem P together with energy states (e.g., solutions) found or identified during runs on the quantum annealer may be available. This example may also assume that there is a budget b∈ [symbol] , b>0 on the maximum number of qubits that can be used by the quantum annealer. This example may also assume that there is a set V of n integer variables {v₀, v₁, . . . , vₙ} that are in the domain of the problem P and are to be one-hot encoded into binary variables (qubits). The machine learning model M is configured to generate a distribution d for each variable v∈V. For example, v₀ may be an integer variable represented as [0,100]. The integer variable 11 may be represented by [0,1000].

The model can be trained to learn or predict the most likely range within each of the integer variables when a new instance of the problem P is presented.

The method 300, may include a training phase and an operational phase. The training phase may be performed independently of the operational phase. The training phase may include training the model and the operational phase may include generating predictions or distributions.

In this example, the method 300 includes training 302 a model to generate or predict a distribution of all integer variables in the set V in terms of their parameters. The historical data D may include a vector of data related to the problem P and the vector may encode, by way of example, number of variables, number of multiplications between variables, a vector w related to each variable that may represent mean, median, minimum integer or maximum integer.

The model may be configured to predict or generate a Gaussian distribution. In the case of a Gaussian distribution, the mean (μ) and standard deviation (σ) can be determined. In this example, a large value of σ indicates a spread in the distribution that indicates a lack of information on the integer variable. Using these parameters, a range may also be estimated or determined (e.g., variables within one or more standard deviations of the mean). Other distributions may also be used. Thus, the distribution may be translated into a range of the original interval.

In one example:

$$v = {\sum }_{k = {i}^{′}}^{{f}^{′}} k \cdot {y}_{k} ; v ∈ [ {v}_{{i}^{′}} , {v}_{{f}^{′}} ] , ( μ , σ ) = M ( p . w ) .$$

In this example, v is the integer variable to be encoded. In one example of determining a range within the integer variable, v_{i′}=|μ−3·σ0| and v_{f′}=|μ+3·σ|. In one example, yₖ are the new binary variables of the reformulation. The approximation of the new interval or range [v_{i′}, v_{f′}] within the original interval is performed to obtain an expressive part of the gaussian distribution (μ, σ). In addition, the sum of yₖ is 1 in one example. In other words, the range of the integer variable to be encoded may be within three standard deviations of the mean by way of example. As an example, the use of a Gaussian distribution is discussed. However, other distributions that are close to the distribution of the most likely solutions and have a different criteria to get the appropriate interval or a set of feasible points could also be used. In one example, one can use a bimodal or other multimodal distribution.

When a distribution for an integer variable is generated, the distribution may include the probability of the values that x may be according to the prediction of the model.

The distributions are used to prune values of yₖ that can represent this integer variable v when transformed to a binary form. When yₖ=1, then v=k and all other variables yₖ are zero in the final assignment.

For example, an integer variable v may be delimited by [0,100]. The model may predict 304 a distribution. A range of [20,50] may be determined from the predicted distribution. This may depend on the mean and standard deviation of the distribution. The model (or multiple models) may generate or predict 304 a distribution for each of the integer variables of the problem. A range for each of the integer variables may be determined 306 based on the associated distributions.

Stated more generally, the model may predict a distribution κ for an integer variable. Using the distribution κ and the integer variable v, a set of binary variables \tilde{x} is generated, each with its own coefficient, while using |\tilde{x}|≤b qubits. In one example, |\tilde{x}| is a relatively small value that can be derived from the distribution κ by a heuristic or it can be fixed.

Thus, a one-hot encoding for each of the integer variables may be generated 308 using the associated ranges (e.g., [v_{i′}, v_{f′}]) determined from the distributions generated by the model, the QUBO may be formulated using the binary variables for each integer variable in the problem. The problem can be encoded using fewer qubits because the number of binary variables needed to encode the integer variables has been reduced using the model and historical data.

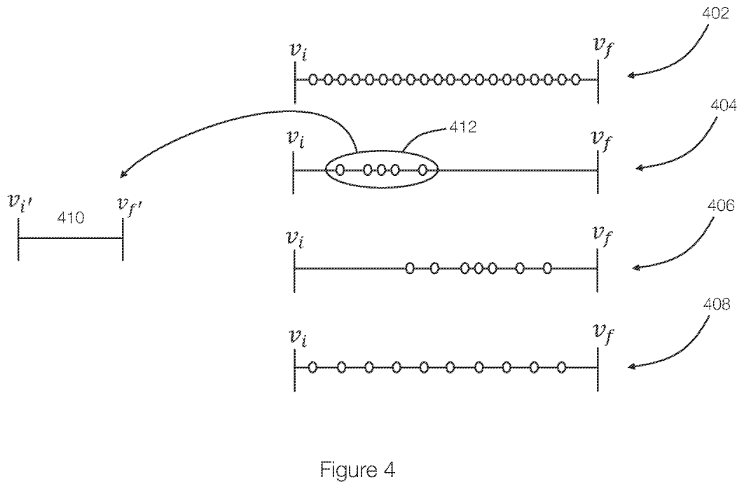

FIG. 4 discloses aspects of one-hot encoding an integer variable or of point distribution. The point distribution 402 illustrates an encoding of an integer variable delimited by [vᵢ, v_{f}]. Each point on the point distribution 402 represents a binary variable and corresponds to an integer in the interval delimited by [vᵢ, v_{f}]. In the point distribution 402, the binary variables are uniformly distributed. However, some of these binary variables may never be activated because just one of this set of binary variables must be true at any given moment.

In the point distribution 404, the integer variable delimited by [vᵢ, v_{f}] was input to a model as described herein. From the distribution generated by the model, a subset of binary variables (e.g., a range [v_{i′}, v_{f′}]) was identified as the most likely binary variables to be activated. The QUBO formed from the binary variables identified in the point distribution 404 requires fewer qubits compared to the point distribution 402. The point distribution 404 illustrates that the range is closer to vᵢ. The point distribution 406 represents a different distribution and also illustrates that the problem can be solved using fewer qubits. The point distributions 404 and 406 are distributed according to some prior knowledge provided or learned by the model.

The point distribution 408 illustrates that there is no priori information other than that valid values must be odd in this example. The distributions may include Gaussian distributions or other statistical distributions, or the like.

FIG. 4 illustrates, for example, that a most probable distribution of points 412 are translated to a range 410 [v_{i′}, v_{f′}], which is smaller in size (number of integers) than the original interval of the integer variable [vᵢ, v_{f}].

In one example, the range can be expanded due to the savings in qubits. For example, additional qubits may be used for other integer values in the integer variable in addition to those predicted by the model.

Embodiments of the invention may be transparent to a user and is a process that improves on conventional one-hot encoding of integer variables in quantum annealing. Embodiments of the invention can also be fine-tuned to save qubits or to increase the granularity or range depending on the problem. Embodiments of the invention identify ranges that are likely good ranges for one-hot encoding.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, data protection operations which may include, but are not limited to, gated quantum computing operations, quantum annealing operations, compression operations, quantization operations, decompression operations, table construction operations, translation operations, or the like or combination thereof. More generally, the scope of the invention embraces any operating environment in which the disclosed concepts may be useful.

New and/or modified data collected and/or generated in connection with some embodiments, may be stored in a data storage environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to perform operations initiated by one or more clients or other elements of the operating environment.

Example cloud computing environments, which may or may not be public, include storage environments that may provide data protection functionality for one or more clients. Another example of a cloud computing environment is one in which processing, data protection, and other, services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, a particular client may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, data storage system components such as databases, storage servers, storage volumes (LUNs), storage disks, and the like, may take the form of software, physical machines, containers, or virtual machines (VM), though no particular component implementation is required for any embodiment.

Example embodiments of the invention are applicable to any system capable of storing and handling various types of objects, in analog, digital, or other form.

It is noted that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments of the invention. These are presented only by way of example and are not intended to limit the scope of the invention in any way.

### Embodiment 1

A method comprising: predicting a distribution, with a machine learning model, of an integer variable associated with a problem input to an orchestration system, wherein the integer variable includes [vᵢ, v_{f}], determining a range within [v_{i′}, v_{f′}] based on the predicted distribution, and generating a one-hot encoding of problem using only integers in the range.

### Embodiment 2

The method of embodiment 1, wherein the distribution is a Gaussian distribution.

### Embodiment 3

The method of embodiment 1 and/or 2, wherein the machine learning model is trained using historical data that includes previously executed problems, the problems including QUBO problems.

### Embodiment 4

The method of embodiment 1, 2, and/or 3, wherein the historical data includes a vector related to the problem, wherein the vector, for each instance of the problem, encodes a number of integer variables, a number of multiplications between the integer variables, a minimum integer, a maximum integer, a mean, and a median for each of the integer variables.

### Embodiment 5

The method of embodiment 1, 2, 3, and/or 4, further comprising inputting a vector for the problem into the machine learning model.

### Embodiment 6

The method of embodiment 1, 2, 3, 4, and/or 5, wherein the range includes all probable points from a distribution, wherein the probable points are translated to a new interval.

### Embodiment 7

The method of embodiment 1, 2, 3, 4, 5, and/or 6, further comprising fine-tuning the range to increase a granularity or to increase the range.

### Embodiment 8

The method of embodiment 1, 2, 3, 4, 5, 6, and/or 7, wherein the one-hot encoding requires qubits equal to a number of integers in the range, which is less than a number of integers in [vᵢ, v_{f}].

### Embodiment 9

The method of embodiment 1, 2, 3, 4, 5, 6, 7, and/or 8, wherein the problem includes integer variables, further comprising using the machine learning model to predict a distribution for each of the integer variables and determining a range for each of the integer variables.

### Embodiment 10

The method of embodiment 1, 2, 3, 4, 5, 6, 7, 8, and/or 9, further comprising one-hot encoding each of the ranges and submitting the encoded problem to a quantum annealing system.

### Embodiment 11

A system, comprising hardware and/or software, operable to perform any of the operations, methods, or processes, or any portion of any of these, disclosed herein.

### Embodiment 12

A non-transitory storage medium having stored therein instructions that are executable by one or more hardware processors to perform operations comprising the operations of any one or more of embodiments 1-10.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, engine, agent, service, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

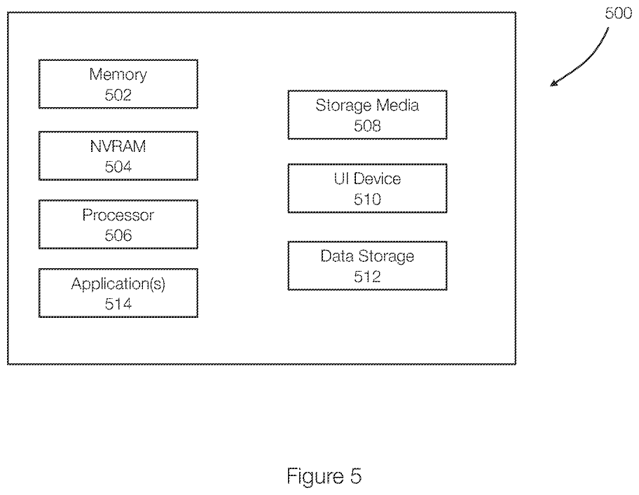

With reference briefly now to FIG. 5, any one or more of the entities disclosed, or implied, by the Figures and/or elsewhere herein, may take the form of, or include, or be implemented on, or hosted by, a physical computing device, one example of which is denoted at 500. As well, where any of the aforementioned elements comprise or consist of a virtual machine (VM), that VM may constitute a virtualization of any combination of the physical components disclosed in FIG. 5.

In the example of FIG. 5, the physical computing device 500 includes a memory 502 which may include one, some, or all, of random access memory (RAM), non-volatile memory (NVM) 504 such as NVRAM for example, read-only memory (ROM), and persistent memory, one or more hardware processors 506, non-transitory storage media 508, UI device 510, and data storage 512. One or more of the memory components 502 of the physical computing device 500 may take the form of solid state device (SSD) storage. As well, one or more applications 514 may be provided that comprise instructions executable by one or more hardware processors 506 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The device 500 may represent a server, a service, or the like. For example, the orchestration engine, the encoding engine, and/or model may be implemented as a computing system that is cloud-based or on-premise based. Client device may submit QUBOs to the orchestration engine and embodiments of the invention operate to identify ranges of integer variable for performing one-hot encoding operations.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
predicting a distribution, with a machine learning model, of an integer variable associated with a problem input to an orchestration system, wherein the integer variable includes [vᵢ, v_{f}];
determining a range within [v_{i′}, v_{f′}] based on the predicted distribution; and
generating a one-hot encoding of problem using only integers in the range.

2. The method of claim 1, wherein the distribution is a Gaussian distribution.

3. The method of claim 1, wherein the machine learning model is trained using historical data that includes previously executed problems, the problems including QUBO problems.

4. The method of claim 3, wherein the historical data includes a vector related to the problem, wherein the vector, for each instance of the problem, encodes a number of integer variables, a number of multiplications between the integer variables, a minimum integer, a maximum integer, a mean, and a median for each of the integer variables.

5. The method of claim 1, further comprising inputting a vector for the problem into the machine learning model.

6. The method of claim 1, wherein the range includes all probable points from a distribution, wherein the probable points are translated to a new interval.

7. The method of claim 1, further comprising fine-tuning the range to increase a granularity or to increase the range.

8. The method of claim 7, wherein the one-hot encoding requires qubits equal to a number of integers in the range, which is less than a number of integers in [vᵢ, v_{f}].

9. The method of claim 1, wherein the problem includes integer variables, further comprising using the machine learning model to predict a distribution for each of the integer variables and determining a range for each of the integer variables.

10. The method of claim 9, further comprising one-hot encoding each of the ranges and submitting the encoded problem to a quantum annealing system.

11. A non-transitory storage medium having stored therein instructions that are executable by one or more hardware processors to perform operations comprising:
predicting a distribution, with a machine learning model, of an integer variable associated with a problem input to an orchestration system, wherein the integer variable includes [v_{i′}, v_{f′}];
determining a range within [v_{i′}, v_{f′}] based on the predicted distribution; and
generating a one-hot encoding of problem using only integers in the range.

12. The non-transitory storage medium of claim 11, wherein the distribution is a Gaussian distribution.

13. The non-transitory storage medium of claim 11, wherein the machine learning model is trained using historical data that includes previously executed problems, the problems including QUBO problems.

14. The non-transitory storage medium of claim 3, wherein the historical data includes a vector related to the problem, wherein the vector, for each instance of the problem, encodes a number of integer variables, a number of multiplications between the integer variables, a minimum integer, a maximum integer, a mean, and a median for each of the integer variables.

15. The non-transitory storage medium of claim 1, further comprising inputting a vector for the problem into the machine learning model.

16. The non-transitory storage medium of claim 1, wherein the range includes all probable points from a distribution, wherein the probable points are translated to a new interval.

17. The non-transitory storage medium of claim 1, further comprising fine-tuning the range to increase a granularity or to increase the range.

18. The non-transitory storage medium of claim 17, wherein the one-hot encoding requires qubits equal to a number of integers in the range, which is less than a number of integers in [vᵢ, v_{f}].

19. The non-transitory storage medium of claim 11, wherein the problem includes integer variables, further comprising using the machine learning model to predict a distribution for each of the integer variables and determining a range for each of the integer variables.

20. The non-transitory storage medium of claim 19, further comprising one-hot encoding each of the ranges and submitting the encoded problem to a quantum annealing system.
